(19) United States
(12) Patent Application Publication
(10) Pub. No.: US 2022/0309450 A1
(43) Pub. Date: Sep. 29, 2022

(54) Multiple Recipient Code Based Item Delivery Logistics System

(71) Applicant: International Business Machines Corporation, Armonk, NY (US)

(72) Inventors: Sanchita Mishra, Pune (IN); Akash U. Dhoot, Pune (IN); Venkata Vara Prasad Karri, Visakhapatnam (IN); Shailendra Moyal, Pune (IN)

(21) Appl. No.: 17/212,622

(22) Filed: Mar. 25, 2021

(51) Int. Cl. G06Q 10/08; G06N 20/00; G06K 7/14

(52) U.S. Cl. CPC G06Q 10/0832; G06N 20/00; G06Q 10/0833; G06K 7/1417

(57) ABSTRACT

Artificial intelligence (AI) based goods delivery logistics are provided. A trusted entity-to-entity mesh (TEEM) data structure is generated for a user, which specifies relationships between the user and other entities as potential surrogate recipients of physical packages. AI computer model(s) perform AI analysis of characteristics of the relationships resulting in surrogate recipient scores for each of the entities. The entities are ranked relative to one another according to their surrogate recipient scores and a set of one or more selected entities are selected, from the entities, as potential surrogate recipients of a physical. An encoded multi-recipient information code (MRIC) is generated for the physical package specifying characteristics of each of the one or more selected entities, in an encoded format. Delivery of the package to a recipient is controlled based on the MRIC and dynamic delivery conditions, where the recipient is one of the user or a surrogate recipient.

### BACKGROUND

The present application relates generally to an improved data processing system and method and more specifically to mechanisms for leveraging artificial intelligence mechanisms to generate multiple recipient codes for use in identifying alternative recipients for delivery of physical items.

Item or goods deliveries by delivery services have been an important part of our societies for quite some time. These delivery services may be large scale delivery services as the United States Postal Services (USPS), United Parcel Service (UPS®)(a registered trademark of United Parcel Service of America, Inc.), FEDEX® (a registered trademark of Federal Express Corporation), and the like, or smaller scale local delivery services, such as local or regional couriers and/or the like. Even in the modern era, delivery services are still an important part of being able to transport and deliver physical items/goods to recipients, and may be even more important as individuals rely more heavily on electronic commerce (e-commerce) and online retailers, such as AMAZON™, to obtain the items/goods that they need or desire.

The current delivery service logistics processes require the intended recipient to be physically present at the delivery location when the delivery is attempted. If a delivery cannot be completed because the recipient is not present when the delivery is to occur, the goods may be left in an unsecured location where they may be stolen, or the delivery personnel may leave a notice for the recipient to contact the delivery service to arrange for alternative delivery timing. This results in repeated delivery attempts and/or communications between the recipient and the delivery service personnel, and/or may result in loss and replacement of goods. This in turn increases the delivery costs, goods provider costs, and leads to significant customer dissatisfaction.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided in a data processing system comprising at least one processor and at least one memory, the at least one memory comprising instructions executed by the at least one processor to specifically configure the at least one processor to execute operations of the method. The method comprises generating a trusted entity-to-entity mesh (TEEM) data structure for a user, the TEEM data structure comprising relationships between the user and one or more other entities that are potential surrogate recipients of physical packages by a delivery service. The method further comprises performing, by one or more artificial intelligence (AI) computer models executing on the data processing system, AI analysis of characteristics of the relationships between the user and the one or more other entities resulting in surrogate recipient scores for each of the one or more other entities. The method also comprises ranking the one or more other entities relative to one another according to their surrogate recipient scores, and selecting a set of one or more selected entities, from the one or more entities as potential surrogate recipients of a physical package whose intended recipient is the user. Moreover, the method comprises generating an encoded multi-recipient information code (MRIC) for the physical package specifying characteristics of each of the one or more selected entities in the set of one or more selected entities, in an encoded format. In addition, the method comprises controlling delivery of the package to a recipient based on the MRIC and dynamic delivery conditions, wherein the recipient is one of the user or a surrogate recipient that is a selected entity in the set of one or more selected entities.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a block diagram depicting a multi-recipient information code (MRIC) based goods delivery logistic system in accordance with one illustrative embodiment;

FIG. 2 is a flowchart outlining an example process of an improved computing tool with regard to the generation of a trusted entity-to-entity mesh (TEEM) for a registered recipient in accordance with one illustrative embodiment;

FIG. 3 is a flowchart outlining an example process of an improved computing tool with regard to the generation of an MRIC in accordance with one illustrative embodiment;

FIG. 4 is a flowchart outlining an example process of an improved computing tool with regard to the use of an MRIC by a delivery service for routing delivery of a package to a surrogate recipient in accordance with one illustrative embodiment;

FIG. 5 is an example diagram of a distributed data processing system in which aspects of the illustrative embodiments may be implemented; and

FIG. 6 is an example block diagram of a computing device in which aspects of the illustrative embodiments may be implemented.

### DETAILED DESCRIPTION

As noted previously, current delivery service logistics systems result in increased costs and dissatisfaction by the parties involved in the delivery of items/goods from an item/goods provided to a recipient. There is a need to provide an improved computing system that allows both the parties (provider and recipient) a reliable and secure approach to providing hassle-free anytime, anywhere delivery with less burden to the delivery service provider than current approaches, such as one-time-password (OTP) mechanisms or repeat delivery attempts. In addition, it would be beneficial to provide an improved computing system and items/goods delivery service logistics system that provides lower costs, lower dissatisfaction, and increased security with increased flexibility such that items/goods are not compromised or end up landing in incorrect hands, and provides alternative delivery locations and surrogate recipients for a registered recipient determined through an artificial intelligence approach.

The illustrative embodiments address the failings of the current delivery service logistics system by providing improved artificial intelligence based computing systems for determining alternative delivery locations and surrogate recipients based on a mesh of relationships between the intended recipient and other authorized surrogate recipients. In addition, the illustrative embodiments provide mechanisms for generating a ranked listing of authorized surrogate recipients and encoding this ranked listing, and potentially characteristics of the surrogate recipients, into a multi-recipient information code (MRIC) which may be affixed or otherwise associated with the package in which the items/goods are transported. Furthermore, the illustrative embodiments provide mechanisms for the delivery personnel, i.e. the couriers, distribution hubs, or the like, to access and utilize such MRICs and dynamically determine an alternative location/surrogate recipient for delivery of the package based on various characteristics of the ranked surrogate recipients, as well as various characteristics of the static delivery conditions, e.g., weight and/or other dimensions of the package, fragility of the items/goods, reported value of the items/goods, confidentiality of the items/goods, etc. and current dynamic delivery conditions, e.g., time of day, day of week, weather conditions, etc.

As a result, the illustrative embodiments provide mechanisms that improve the way in which delivery service for items/goods is performed. The mechanisms involve a variety of artificial intelligence computing systems that evaluate a large number of factors to determine an appropriate location/surrogate recipient to which to deliver the item/goods on behalf of a registered recipient without having to use one-time-password communications, repeated delivery attempts, or other known approaches that lead to inconvenience and frustration on the part of the registered recipient. Moreover, the mechanisms of the illustrative embodiments provide an improved computing system that lessens the likelihood that the items/goods are delivered to a location that is not secure and thus, lessens the likelihood that the items/goods may be stolen or otherwise retrieved by unauthorized persons.

Before beginning the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

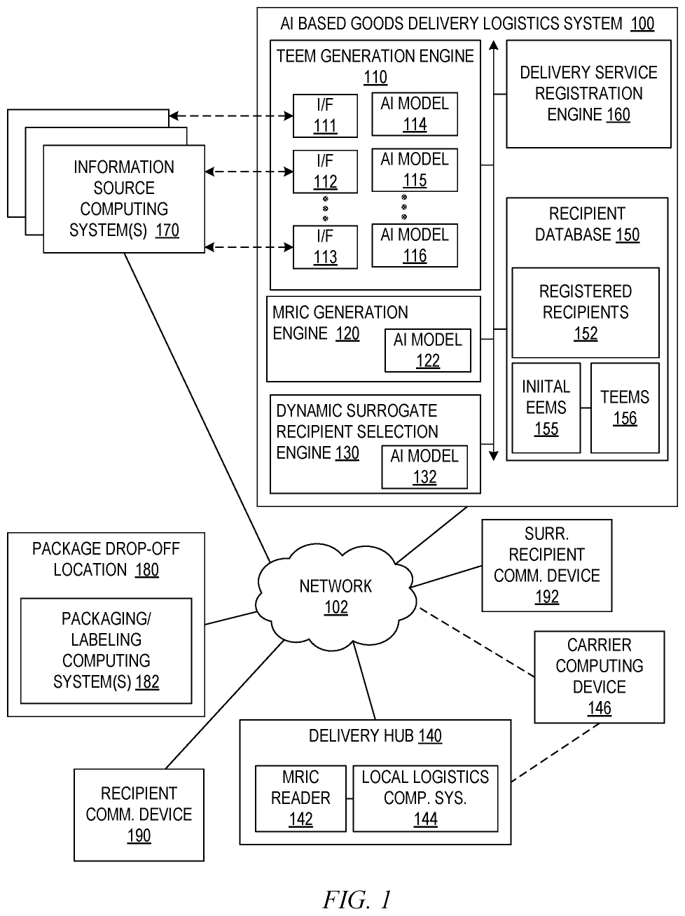

As mentioned above, the illustrative embodiments provide an improved artificial intelligence based logistics system for generating a ranked listing of surrogate recipients for a physical package containing items/goods to be delivered to an intended recipient, generating a multi-recipient information code (MRIC) for associating the ranked listing of surrogate recipients with the physical package, and for dynamic use of the MRIC to identify a surrogate recipient based on static and dynamic delivery conditions. FIG. 1 is a block diagram depicting an example artificial intelligence (AI) based goods delivery logistic system in accordance with one illustrative embodiment. As shown in FIG. 1, the AI based goods delivery logistics system 100 comprises a trusted entity-to-entity mesh (TEEM) generation engine 110, a multi-recipient information code (MRIC) generation engine 120, a dynamic surrogate recipient selection engine 130, and a carrier communication interface 140. The AI based goods delivery logistics system 100 further includes a recipient database 150 as well as delivery service registration engine 160 and recipient/surrogate recipient messaging and which operate to provide graphical user interfaces and the like to allow recipients and surrogate recipients to register with the delivery service by providing information about the recipient/surrogate recipient which is stored in the recipient database 150, and for communicating with the recipient/surrogate recipient to negotiate delivery of packages to surrogate recipients.

Initially, a user may register for delivery services from a delivery service provider, e.g., USPS, UPS®, FEDEX®, AMAZON™, or the like, via the delivery service registration engine 160. The user may be presented with various user interfaces for gathering data about the user (e.g., name, home address, employer name and address, contact information, and the like) and the user's social networking website and professional networking website account details (e.g., user identifiers on the various websites), communication device identifiers (e.g., mobile telephone numbers, instant messaging user account information, and device identifiers, such as MAC address, IP address, etc.), and an initial set of connections with the user, e.g., names and contact information for family, friends, and co-workers, as well as other information about the user that will be useful to identifying relationships between the user and other potential surrogate recipients for packages to be delivered to the user, depending on the desired implementation. Through this process, the user may be required to agree to certain access levels of access to the user's personal data as well as consent for communicating with other parties (e.g., surrogate recipients) and delivery of packages to other parties on behalf of the user.

In some illustrative embodiments, with user consent, the registration information may be obtained automatically through accessing data on a user's computing and/or mobile communication device(s), e.g., accessing a user's contacts information in their mobile phone, electronic mail applications, instant messaging applications, accessing social networking website information, accessing professional networking website information, etc. The information gathered through registration of the user via the delivery service registration engine 160 may be stored in the recipient database 150 for use by other components of the AI based goods delivery logistics system 100. This information may be updated periodically.

The initial registration information may be used to generate a registered recipient entry data structure of the registered recipient entries 152 and an initial entity-to-entity mesh (EEM) data structure 155 for the user's entry in the recipient database 150 based on an initial set of relationships between the user and the specified family, friends, and/or co-workers. The user's entity-to-entity mesh data structure 155 may be stored in association with the user's entry in the recipient database 150, or another data structure linked or otherwise associated with the user's entry in the recipient database 150.

The entity-to-entity mesh data structure 155 is an ontology data structure that comprises nodes representing entities and their characteristics, and edges representing relationships between the entities. An edge connects two entities and may have various characteristics indicating a type of relationship between the two connected entities. For example, a node may represent the user and may have various characteristics information about the user including name, home address, work address, etc. Another node may represent a relative of the user and the edge between the user and the relative of the user may have a relationship type of “family” or even more specifically, “father”, “mother”, “sister”, “brother”, or the like. Similar sorts of nodes and edges may be generated for each of the other entities that the user specifies in the registration information, such as co-workers, friends, and the like, with corresponding edge types connecting the node representing the user to nodes representing these other entities in the entity-to-entity mesh data structure 155. Thus, for example, for each entity specified in the registration information, a corresponding node may be generated and an edge between a node representing the registered recipient (user) and a node representing the specified entity may be generated, with the edge having a type corresponding to the type of relationship specified in the registration information. This initial entity-to-entity mesh (EEM) data structure 155 may serve as a basis upon which additional information about the specified entities may be acquired through data mining and accessing of information source computing devices with requests for information about these entities, and as a basis for expanding the initial EEM data structure 155 to include additional entities and edges discovered through such data mining and information gathering from these various source computing systems and performing deep data mining, analysis, and pattern recognition.

Through such deep data mining, analysis, and pattern recognition, the initial EEM data structure 155 is updated to a full entity-to-entity mesh data structure 155 where the entities in the updated EEM are further evaluated with regard to trustworthiness as discussed hereafter, such that the updated EEM may also be referred to herein as the trusted entity-to-entity mesh (TEEM) data structure, or simply TEEM. The deep data mining, analysis, and pattern recognition may be performed via operation of the AI based mechanisms of the illustrative embodiments. These AI based mechanisms confirm and expand the initial EEM data structure 155 through AI analysis of data gathered from various sources of information 170, such as social networking websites, professional networking websites, electronic communication services, location determination services (e.g., global positioning system (GPS) data, mapping services (e.g., GOOGLE® MAPS™), and the like. This information may be updated periodically so as to keep the TEEM accurate based on an updated AI based analysis of the information from these various sources of information 170 regarding relationships between the user and other entities.

The TEEM generation engine 110 is responsible for generating the initial EEM data structure 155 based on the registration information obtained from the user, and to expand this initial EEM data structure 155 to generate the TEEM data structure 156 that expands and replaces the initial EEM data structure 155. The TEEM generation engine 110 comprises data collection interfaces (I/F) 111-113 comprising computer executed logic for communicating with information source computing systems 170 and gathering, for a registered recipient (e.g., the “user” referenced above), personal information about the registered recipient, and/or potentially related entities to the registered recipient, from the various information sources 170. The TEEM generation engine 110 further comprises one or more artificial intelligence computer models 114-116 that receives the gathered information as input data, extracts predetermined sets of features from the gathered information, and processes the sets of features to generate classifications of different types of characteristics for entities and relationships between entities and the registered recipient based on probabilities and predictions corresponding to the patterns of features in the sets of features. For example, the one or more artificial intelligence computer models 114-116 may be machine learning based computer models, trained through a machine learning training process (e.g., supervised or unsupervised machine learning), where the machine learning trains the corresponding artificial intelligence computer models 114-116, by modifying operational parameters of the models 114-116 to reduce errors, or loss, in classifications or prediction outputs of the models 114-116. As an example, the artificial intelligence computer models 114-116 may be neural networks (NNs), convolutional neural networks (CNNs), deep learning neural networks (DNNs), random forests, support vector machines (SVMs), other linear or logistic regression-based computer models, rules-based engines having predefined rules (but whose variables may be dynamically adjusted based on machine learning, e.g., weighting values of various variables) for evaluating various characteristics of the registered recipient (user) and other entities, and the like.

In some illustrative embodiments, the machine learning process used to train the artificial intelligence computer models 114-116 may comprise a supervised machine learning process in which a training dataset is used that has correct classifications/predictions (also referred to as “labels”) associated with each set of input features in the training dataset, i.e. a ground truth. A set of features from the training dataset are input to the computer model 114 being trained which processes the features and generates an output classification/prediction. A difference between the output classification/prediction generated by the computer model 114 and the correct classification/prediction for the set of features is determined, i.e., the error or loss. A machine learning training algorithm is applied, e.g., a linear or logistic regression, to modify operational parameters of the computer model 114, e.g., weights of nodes or the like, based on the determined error/loss. The modified operational parameters are applied to the computer model 114 to thereby change the computer model 114 in an effort to reduce the error/loss. The process is then repeated for the same or different sets of features, such as repeated for another set of features in the training dataset. This process may be repeated through multiple “epochs” until the error/loss is within a predetermined tolerance, i.e., is equal to or lower than a predetermined acceptable value, or until a predetermined number of epochs are reached, at which point the computer model 114 is considered to have been trained. The trained computer model 114, assuming it achieves an acceptable level of performance, e.g., acceptable level of accuracy and/or error/loss, may then be deployed for runtime processing new sets of features from new input data so as to perform classifications/predictions for the new input data which does not have associated correct classification/prediction (e.g., ground truth labels) associated with it.

With regard to runtime processing, the models 114-116 process the features extracted from the gathered information and generate classifications/predictions as to whether particular entities are sufficiently related to the registered recipient (user) being evaluated and what type of relationship these entities have with the registered recipient (user). For example, a model 114 may receive registered recipient information that includes, among other information, the registered recipients' GPS coordinates for their home and may also receive information for another potentially related entity which may include the GPS coordinates for their home. The model 114 may extract the GPS coordinates features from the information received from the information source computing systems 170 and may evaluate that GPS coordinate information, potentially along with other features, to generate a prediction or classification as to whether the other entity lives with the registered recipient, is a neighbor of the registered recipient, or the like, e.g., if the distance between the GPS coordinates of the home locations is less than a predetermined amount, this is more indicative that the parties are family, friends, or neighbors. It can be appreciated that the particular classifications/predictions may be of various different levels of granularity and may be of various different levels of complexity depending on the desired implementation.

Based on these classifications/predictions, the initial entity-to-entity mesh data structure 155 is updated and potentially expanded to generate the TEEM data structure 156 that replaces the initial entity-to-entity mesh data structure 155. The TEEM generation engine 110 generates the TEEM data structure 156, using the initial entity-to-entity mesh data structure 155 as a basis, by gathering data via various channels (public, private, and hybrid), extracting features from this data (or information), and processing these features through one or more AI models 114-116. One or more of these AI models 114-116 may include AI models 114-116 for deriving personality insights which provide insights into the willingness of particular entities to be engaged in a surrogate recipient arrangement or not, and with regard to specific delivery conditions. Examples of such personality insight generating AI computing systems or AI models 114-116 that process data through applied analytics, such as data mining and pattern analysis analytics, and which then generate classifications/predictions based on inferences gathered from the features of the data may include, but are not limited to, IBM WATSON™ Tone Analysis, IBM WATSON™ Sentiment Analysis, IBM WATSON™ social insights, and the like.

The various channels are utilized by the interfaces 111-113 to access data from the various information sources which may include social and professional networking websites, as well as electronic communication systems such as instant messaging, electronic mail, and other systems for performing data based communications. As noted above, various types of applied analytics may be executed on the gathered data to perform data mining and data pattern analysis to extract features from the data that are of use to generating a trusted entity-to-entity mesh, with these features being input to corresponding models 114-116 for processing and generation of classifications/predictions. With regard to the personality insights data, this information may be obtained from known personality insight computing systems, such as those listed above, and used to evaluate the registered recipient (user) and other entity's interest level and engagement level based on historical data for events, historical data for communications between these parties, historical location data, and the like, to determine if the parties are interested in being surrogate recipients for each other.

The applied analytics may be data analytics that are executed on the logging done by a social networking website application, data analytics comprising natural language processing (NLP) executed on contents and/or metadata associated with communications occurring via such websites, applications, or the like. For example, using NLP as an example, the applied analytics may determine an engagement level of users based on an analysis of keywords and/or key phrases used in the communications, e.g., “lets meet today”, “I will catch you up at home in evening”, and the like indicate a relatively higher level of engagement between the parties to the communication than other keywords or key phrases. By evaluating a plurality of such communications using NLP mechanisms and other data analytics, an engagement level summary of the connected users may be generated. Based on this engagement level summary, the registered entity's engagement levels with each other entity in the TEEM data structure may be determined and ranked based on relative level of engagement. Similarly, such ranking can also be done with other aspects or characteristics of the communications or interfacing between entities, such as the number of communications or interactions within a predetermined time period, the amount of time of interaction, and the particular times of the day, week, month, year, etc. of the interactions, as well as patterns of the communications.

As an example, when the registered recipient (hereafter referred to as the “user” to differentiate the registered recipient from other potentially related recipients or entities) registers, the user specifies their account information for various social networking websites, professional networking websites, communication systems, etc. The TEEM generation engine 110, via the one or more interfaces 111-113 and their corresponding data gathering logic, may access these systems 170 and identify entities with which the user has some contact, e.g., mentions in posts on websites, is listed in a “friends” list on the website, is employed by the same employer at the same employer location, sends messages or communications to, and/or receives messages/communications from the other entity, etc. The one or more interfaces 111-113 comprise logic for sending requests to and processing responses from the various information source computing systems 170. A listing of potentially related entities is generated and further information regarding these entities is gathered from the information sources.

The information gathered from the various sources of information, i.e., source computing systems 170, comprises various different attributes or characteristics of the user and other entities in the listing of potentially related entities. The information may include any historical information, such as may be logged by the various source computing systems 170, such as logs of engagements (e.g., communications) present in social network feeds, public/workplace collaboration computing system stacks, etc., logs or historical data regarding location indicative of travel paths, inbox/sent electronic communication logs or storage, or the like, which can provide information as to the historical events representing engagements or encounters between the entities (where the “entities” refers to the user and the potentially related entities), location of entities in the past, etc. Any information that may be analyzed by artificial intelligence based computing systems to identify correlations in patterns of characteristics of the entities may be used to find out, for example, how often entities are communicating, and through which communication channels the communication occurs, as well as location of the entities relative to one another at various timings, such that patterns of general timing and location of the two entities may be derived to determine if the two entities are meeting, crossing paths, near-by, etc. It should be appreciated that the information that is gathered and accessed is, for security purposes, only information that is within the scope of agreed consent between the involved parties, otherwise the information that may be utilized will be of a high-level, i.e., non-personally identifiable information, but may result in lower performance of the AI based goods delivery logistics system 100.

Thus, examples of the information that may be accessed from these various information source computing systems 170 include logged or stored location information for various times of day, times of the week, home locations of entities (registered recipient (user) and potential surrogate recipients), work locations of entities, personal demographics and attributes, communications information for communications between the parties including natural language content of the communications and metadata of the communications (e.g., timestamps, durations, etc.), travel path information, driving path information, and the like. It should be appreciated that the information may include more information than is utilized as input to the various AI models 114-116 and thus, only features of interest to the processing by the AI models 114-116 may be extracted from the information. Moreover, the features may include features extracted from communications through computer executed natural language processing, such as terms and/or phrases that the natural language processing logic is configured to identify as terms and/or phrases of familiarity, such as may be used by friends or colleagues, terms and/or phrases used by co-workers, terms and/or phrases used by family members when communicating with one another, or other suitable terms/phrases indicative of particular types of relationships between entities, e.g., there may be different sets of terms/phrases for relationships of different types including family, friends, co-worker, business relationship, etc. In addition, the features may be extracted from metadata information associated with communications, metadata associated with logs from the various source computing systems, and the like. The metadata may specify particular relationships between entities, device identifiers, timestamps, durations, etc.

The extracted features from the gathered information or data from the information source computing systems 170, for each potentially related entity in the listing, may be input to the models 114-116 which processes these features and generates a classification/prediction output indicating whether or not the registered recipient (user) has a relationship with the potentially related entity, as well as attributes or characteristics of a relationship between the registered recipient (user) and the potentially related entity, if one exists. It should be appreciated that the same may be performed for the known related entities, such as those specified in registration information, so as to verify the related entities and update relationship information regarding the related entities. In some illustrative embodiments, the models 114-116 receive particular sets of input features, perform inferences on the input features via neural network processing of the input features, via multiple layers of processing nodes of the model 114-116, based on the trained operational parameters, e.g., weights of nodes and the like, to generate a classification/prediction output. For example, the inference processing may generate probability values corresponding to different predetermined classes with a highest probability value classification being considered the classification for the input data from the viewpoint of that model 114-116. For example, a model 114-116 may generate a classification/prediction output as to a type of relationship, e.g., “friend”, “relative”, “co-worker”, etc., between the registered recipient and other potentially related entities from the generated listing. In some illustrative embodiments, each of the models 114-116 may be associated with a different type of relationship between entities, and may process the input features to generate a score for the corresponding relationship type. The scores may be compared to determine an appropriate classification of the relationship between the registered recipient and the other potentially related entities.

It should be appreciated that each of the models 114-116 may perform separate classifications/predictions with regard to the same or different sets of features extracted from the gathered information. The outputs of the various models 114-116 may be combined to generate a final classification prediction using any suitable aggregation engine which may weight different outputs differently depending on the particular training and implementation. For example, one model 114 may evaluate co-location or travel path information to evaluate whether the registered recipient and the potentially related entity are often or routinely encountering one another or are within a predetermined distance of each other on a regular basis. Another model 115 may evaluate communication features to determine whether the frequency of communication, type of communication, terms/phrases used in the communication, and other communication features indicate that the entities are friends, family, co-workers, or the like. A third model 116 may evaluate social networking and professional networking website posts for the entities to determine a classification of a degree and type of interaction between the entities both on a professional basis and a non-professional basis. The classifications/predictions of these various models 114-116 may then be combined using an aggregation mechanism, with different weightings applied to different model outputs if desired, such as a majority vote aggregation, a weighted scoring aggregation, average aggregation, or any other suitable aggregation mechanism for the desired implementation.

As examples, the models 114-116 may generate classifications/predictions with regard to social and professional connection status and degree of connection attributes, i.e., measures of relationships and relationship types, between the registered recipient and the other entities by evaluating whether the entities (registered recipient and potentially related entity) have commonalities of features indicating one or more types of relationships, e.g., reside in the same city, whether there is a frequency, duration, and/or type of familiarity in the wording of the natural language content in their communications indicative of particular types of relationships, whether the entities are located at the same professional organization, such as may be determined from GPS location information for the organizations associated with the entities (e.g., places of employment), whether the entities frequently cross paths with one another, such as may be determined by frequent crossing time evaluations based on co-location information, which may also be determined from GPS or other location determination services, whether the parties follow the same or substantially similar travel paths at various times of day, days of week, etc., including whether or not the entities are traveling together, such as in a shared vehicle, co-location and/or distance between home locations of the entities, whether the entities regularly meet each other on weekends, and the like.

In some illustrative embodiments, the AI models 114-116 generate surrogate recipient scores for the various identified potentially related entities by evaluating the various features extracted from the gathered information from the information source computing systems 170 to thereby determine a strength of engagement between the user and each of the other potentially related entities. The surrogate recipient scores represent not only a likelihood that another entity will be willing to act as a surrogate recipient for the user with regard to delivery of packages, but also indicate a level of trust between the user and the potentially related entity. Thus, for example, this surrogate recipient score may be based on a combination of a scoring of a type of relationship determined to exist between the user and the other entity, a scoring of an amount of co-location or intersection of location between the user and the other entity, a scoring of a familiarity of communication, degree of communication, and type of communication engaged in between the entities, a scoring of personality insight evaluations for the entities, and the like. Essentially, these various scorings are used to generate scores for factors generally grouped into factor groups related to frequency of communication/interaction between the entities, type of communication/interaction between the entities, physical proximity of the entities, and trust between the entities. Each of these factors, or groupings of factors, may be determined through a classification/prediction of a corresponding AI model 114-116 and the various scorings may be combined, using any desired function, e.g., weighted combination or the like where the weights are set according to a relative importance of the various elements of the combination, so as to generate an overall surrogate recipient score.

The surrogate recipient score may be generated for each potentially related entity identified through the operations previously described above. Thus, each potentially related entity will have a surrogate recipient score that represents a likelihood that the entities will be agreeable to the other entity being a surrogate recipient of items/goods packages from the delivery service on behalf of the user, and a trustworthiness of the entities with regard to each other for the purpose of delivery of items/goods packages to the other entity on behalf of the user. These surrogate recipient scores represent baseline surrogate recipient scores that may be stored in association with the corresponding nodes of the entities in the TEEM 156. The baseline surrogate recipient scores may be dynamically modified based on dynamic delivery conditions for specific packages, as will be discussed hereafter. Again, each user will have their own TEEM data structure 156 and thus, the same entity may appear in different TEEM data structures 156 for different users and may have different surrogate recipient scores in the different TEEM data structures 156 since their relationships with the corresponding users will be different.

The surrogate recipient scores of the various potentially related entities may be used to rank the entities relative to one another with regard to whether the entities should be selected as surrogate recipients for packages on behalf of the user (registered recipient). Such ranking may be performed by the Multi-Recipient Information Code (MRIC) generation engine 120 based on the baseline surrogate recipient scores and a top K number of surrogate recipients may be selected for inclusion of their identities and/or characteristics information in a MRIC to be applied to a package being sent to a registered recipient, e.g., the user. That is, when a package is dropped off at a package drop-off location 180 with an intended recipient being the user, the packaging/labeling computing system 182 at the package drop-off location 180 will receive the identity of the intended recipient and send a request to the AI based goods delivery logistics system 100 for creation of an MRIC. The MRIC generation engine 120 will generate the MRIC based on an initial assessment of the baseline surrogate recipient scores and characteristics of the package being dropped off at the package drop-off location 180 to thereby generate a listing of K top ranked surrogate recipients and their corresponding information.

This listing of the K top ranked surrogate recipients and their corresponding characteristics information may then be encoded for security purposes to thereby generate an MRIC that can be used to access the listing and the characteristics information. The encoded MRIC is preferably not human readable so as to protect any personally identifiable information of the parties. In one illustrative embodiment, the MRIC is a byte coded text where each byte stores information about the surrogate recipients, e.g., name, contact phone number, address, delivery address, delivery acceptance timing(s), types of items/goods accepted, surrogate recipient score (which may be modified from the baseline surrogate recipient score as discussed hereafter), relationship type, etc.

For example, in some illustrative embodiments, the MRIC may resemble a code similar to a bar code of quick response (QR) code, but will have additional data specific to the illustrative embodiments of the present invention encoded in the MRIC. The MRIC code may be scannable using a reader device, such as an optical reader device (e.g., camera) with software capable of understanding the data encoded in the MRIC code. The additional information encoded in the MRIC code may include, among other possible data, data specifying the intended recipient and/or surrogate recipients' names, contact information, address, delivery address, delivery acceptance timing(s), type of items accepted by the surrogate recipient, level of trust by the intended recipient, relationship type with the intended recipient, surrogate recipient score, and the like.

When generating the MRIC, the MRIC generation engine 120 first produces a ranked listing of surrogate recipients based on the TEEM data structure 156 associated with the specified intended recipient. That is, the MRIC generation engine 120 may send a request to retrieve the data for the intended recipient specified by the request from the packaging/labeling computing system 180 at the drop-off location 180. A look-up operation is performed in the registered recipients 152 to find a matching registered recipient and retrieve the matching registered recipient's corresponding TEEM data structure 156. If a matching registered recipient cannot be found, then a default MRIC may be generated by the MRIC generation engine 120 which does not specify any surrogate recipients or a MRIC may not be generated and an appropriate response sent back to the packaging/labeling computing system 182.

Assuming that a matching registered recipient is found and the TEEM data structure 156 is retrieved, the MRIC generation engine 120 then evaluates the characteristics information for the entities specified in the TEEM data structure 156 with regard to the particular characteristics of the package, e.g., weight, size, confidentiality, fragility of the contents of the package, etc. This information may be input to the AI model 122 of the MRIC generation engine 120 which evaluates these characteristics of the package and the characteristics of the entities in the TEEM data structure 156 to thereby modify the baseline surrogate recipient scores to generate package characteristic modified surrogate recipient scores, or simply modified surrogate recipient scores, i.e. the AI model 122 may receive the baseline surrogate recipient score, the package characteristics, and the entity characteristics as inputs and generate a modified surrogate recipient score based on the evaluation by the AI model 122 of the various input data. Again, the AI model 122 may be any one or more of the machine learning computer models discussed previously, similar to the AI models 114-116.

The resulting modified surrogate recipient scores may then be ranked by the MRIC generation engine 120 to thereby generate a modified ranking of surrogate recipients. The top K ranked, where K may be any integer number, e.g., the top 5 ranked (K=5), surrogate recipients may then be selected for inclusion in the MRIC generated by the MRIC generation engine 120. The MRIC generation engine 120 encodes the information about the selected surrogate recipients and provides the generated MRIC back to the packaging/labeling computing system 182 at the package drop-off location 180. The packaging/labeling computing system 182 may operate to generate a shipping label or the like for the package, where the MRIC is included on the shipping label that is affixed to the package, or is otherwise associated with the physical package such that it may be read at shipping locations along the package's route to the intended recipient's location. It should be appreciated that the inclusion of the MRIC on a shipping label is only one way in which the MRIC may be affixed to the package. Other attachments or modes of fixing the MRIC to the package may be used without departing from the spirit and scope of the present invention including using RFID tags, or any other mechanism by which data may be encoded and affixed to a physical object.

The package is then put into the delivery service's shipping network and routed to the delivery hub 140 associated with the geographical region of the intended recipient. The shipping network may comprise various package transport vehicles, location, and personnel, typically comprising multiple computing devices and computer systems that track the transportation of the package from one location to another along a route to the intended recipient from the package drop-off location 180. Once the package is received at the delivery hub 140, the local logistics computing system at the delivery hub 140 uses a MRIC reader device 142 to read the MRIC that is affixed or otherwise associated with the package, e.g., in one illustrative embodiment an image capture device may capture an image of the shipping label affixed to the package and read the information off of the shipping label, which includes the MRIC. It should be appreciated that while an image capture device is described as an example, the illustrative embodiments are not limited to such and any reader device that is configured to read the MRIC in whatever form the MRIC takes may be used without departing from the spirit and scope of the present invention. The reader device is specifically configured to recognize and decode information encoded into the MRIC.

In one illustrative embodiment, the local logistics computing system 144 sends a request to the AI based goods delivery logistics system 100 to obtain a selection of a surrogate recipient from the top K surrogate recipients encoded in the MRIC read by the MRIC reader device 142. In such embodiments, the request may include information for identifying current dynamic delivery conditions, e.g., time of day, day of week, weather, traffic conditions, etc., for delivery in the geographical area of the intended recipient. Alternatively, such information may be automatically obtained by the dynamic surrogate recipient selection engine 130 of the AI based goods delivery logistics system 100, from appropriate source computing systems 170 that provide such information, based on the identified location of the intended recipient to which the package is initially intended to be delivered, e.g., the intended recipient's home address, work address, or other alternative address. In addition, the current dynamic delivery conditions information further includes the current locations for each of the intended recipient and the surrogate recipients listed in the MRIC, as well as the current schedules of the intended recipient and surrogate recipients from their electronic scheduling computing systems, if the entities have previously provided consent to access such electronic scheduling computing systems, e.g., electronic calendars on their computing systems or other personal scheduling applications or systems. These electronic scheduling computing systems may be accessed by the dynamic surrogate recipient selection engine 130 and may be part of the information source computing systems 170, with the dynamic surrogate recipient selection engine 130 having appropriate interfaces (not shown) for sending requests and processing responses to the requests for such information.

In one illustrative embodiment, based on the current dynamic delivery condition information, the AI model 132 of the dynamic surrogate recipient selection engine 130 may process the current dynamic delivery condition information, as well as other information encoded in the MRIC for the various surrogate recipients, and current information about the intended recipient, to thereby score each of the surrogate recipients specified in the MRIC, and the intended recipient, and select a highest scoring recipient based on the dynamic delivery conditions. For example, it may be the case, based on the current dynamic delivery conditions, that the intended recipient is at a location where delivery to the intended recipient can be accomplished and thus, the selection of a surrogate recipient is unnecessary. However, in other cases, the intended recipient may not be in a location where delivery can be accomplished and thus, the selection of a surrogate recipient is performed based on the current dynamic delivery conditions.

Alternative to the processing of all of the surrogate recipients to generate modified surrogate recipient scores, in other illustrative embodiments, the dynamic surrogate recipient selection engine 130 evaluates the intended recipient, and then the surrogate recipients in the MRIC in the order of the listing of surrogate recipients in the MRIC from highest ranking to lowest ranking, stopping at the first of the intended recipient and/or first surrogate recipient that is still a viable surrogate recipient for the package under the current dynamic delivery conditions. That is, the listing of surrogate recipients in the MRIC is already ranked according to surrogate recipient score as previously described above. The dynamic surrogate recipient selection engine 130 picks the highest ranked surrogate recipient from the ranked listing encoded in the MRIC and checks that surrogate recipient's current schedule and location to determine if the surrogate recipient's current location and schedule intersects with a predicted delivery time and location of the package and if so, selects the surrogate recipient as a selected surrogate recipient to receive the package. This may be repeated for each listed surrogate recipient in the ranked listing of the MRIC until a surrogate recipient that has location/schedule matching the predicted delivery time and location is found, or none are found in which case the delivery defaults back to the intended recipient.

Once a selected surrogate recipient is identified from the MRIC, the contact information for the intended recipient and the selected surrogate recipient is retrieved and used to send notifications to the communication devices 190, 192 of these parties. For example, an instant message may be transmitted to the mobile telephone devices 190, 192 of the two parties to initiate a security and trust handshake operation. That is, the instant message sent to the intended recipient's mobile device 190 may request that the intended recipient consent to delivery of the package to the selected surrogate recipient, and the instant message sent to the selected surrogate recipient's mobile device 192 may request that the selected surrogate recipient consent to receiving the package on behalf of the intended recipient at a specified location, e.g., surrogate recipients' home, work, etc. The security and trust handshake operation, in some illustrative embodiments, may make use of existing handshake technology such as tokens, one time passwords, and the like.

The parties may respond with inputs to their devices specifying whether or not they consent to the delivery of the package to the selected surrogate recipient. If both parties do not response with agreement to the delivery of the package to the selected surrogate recipient, then the process may return to selection of the next matching surrogate recipient in the ranked listing of the MRIC until both parties agree to the delivery to the surrogate recipient, or until none of the pairings of intended recipient and selected surrogate recipients results in mutual consent at which point the delivery reverts to the default delivery to the intended recipient.

If both parties agree, or if the dynamic surrogate recipient selection reverts to the default of the intended recipient, then an appropriate response is sent to the local logistics computer system 144 specifying the selected surrogate recipient, or the intended recipient, as the current recipient for delivery of the package. The current recipient for the delivery of the package is updated in the local logistics computing system 144 and package delivery information is transmitted to the carrier computing device146 associated with the carrier that will actually delivery the package to the physical location of the current recipient. As a result, the carrier will deliver the package to the current recipient, which may be a selected surrogate recipient at a different location than the intended recipient and the intended delivery location.

It should be appreciated that while FIG. 1 shows the dynamic surrogate recipient selection engine 130 being part of the AI based goods delivery logistics system 100, the illustrative embodiments do not require this architecture. To the contrary, in other illustrative embodiments, the local logistics computing system 144 at the delivery hub 140 may comprise the dynamic surrogate recipient selection engine 130 and its AI model 132 and may perform the operations described above and attributed to the dynamic surrogate recipient selection engine 130 at the local delivery hub 140 rather than having to send a request to the AI based goods delivery logistics system 100. This alternative embodiment may provide a more real-time evaluation of the surrogate recipients and may be performed, for example, in response to the carrier computing device 146 sending a request in response to a carrier scanning the MRIC on the package using a MRIC reader associated with the carrier computing device 146 (not shown). For example, a delivery person in a delivery truck may scan the MRIC on the label of the package which sends the information to the carrier computing device 146. The carrier computing device 146 may then send a request to the local logistics computing system 144 which performs the operations described above to select a surrogate recipient from the listing encoded in the MRIC, initiate the handshake operation, and send the selected surrogate recipient information to the carrier computing device 146 such that the delivery person knows where to deliver the package, i.e., whether to the intended recipient's location or a surrogate recipient's location.

It should be appreciated that the above operations may be repeated over time as more packages are delivered to different surrogate recipients on behalf of the intended recipient. The results of such deliveries may be logged in log data structures of the recipient database 150, such as part of corresponding entries in the registered recipients 152. These logs may store information for each surrogate recipient identified in the entry's corresponding TEEM 156, with such log information indicating, for example, the types of packages (e.g., confidentiality level, fragility, value of contents, dimensions of package, or the like) delivered to the surrogate recipient, as well as other dynamic delivery conditions under which the surrogate recipient received packages on behalf of the intended recipient. This information may be stored as historical data for each registered recipient and may be input as additional features into the AI models 122, and/or 132 when evaluating the surrogate recipients in the TEEM data structure 156 for selection of a surrogate recipient, i.e., either for inclusion in the MRIC or for dynamic selection from the already encoded ranked listing in a MRIC of a package.

As noted above, the MRIC may be included on a shipping label of the physical package and may be scanned or otherwise read by a MRIC reader device 142 at the delivery hub 140 and/or by the carrier if the carrier has a MRIC reader device as well. While in some illustrative embodiments, the shipping label may include the MRIC as a printed, and thus static, portion of the shipping label, in other illustrative embodiments, the label may have computer chips or other storage technology embedded in the label which may be dynamically updated. In such embodiments, the local logistics computing system 144 may determine the current recipient to which the package is to be delivered in a manner such as previously described above, and may then send an update to the embedded storage technology on the package to update the current recipient delivery information. The carrier may then scan the storage technology and obtain the current recipient delivery information and deliver the package to the current recipient location accordingly. The updates sent to the storage technology affixed to the package may be sent through wireless data transmission, for example, such as a wireless transmission between the MRIC reader 142 or local logistics computing system 144 and the storage technology affixed to the package.

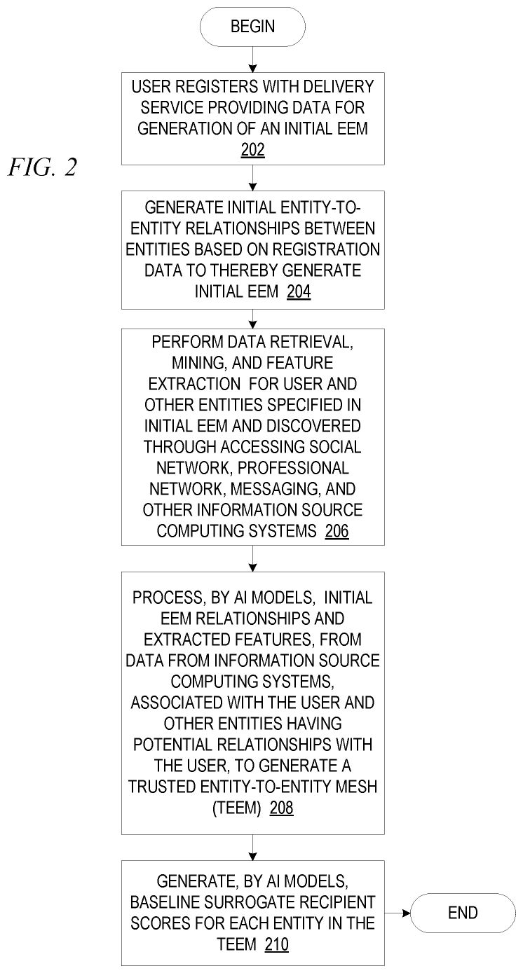

FIG. 2 is a flowchart outlining an example process of an improved computing tool with regard to the generation of a trusted entity-to-entity mesh (TEEM) for a registered recipient in accordance with one illustrative embodiment. The operation outlined in FIG. 2 may be performed for example, by the Trusted Entity-to-Entity Mesh (TEEM) generation engine 110 in combination with the recipient database 150 and delivery service registration engine 160 of the AI based goods delivery logistics system 100 in FIG. 1, for example. Each of the operations set forth in FIG. 2 are performed by specifically configured computer logic implementing these elements of the AI based goods delivery logistics system 100, even though input may be provided by interfacing with a human user in order to perform the registration of the human user as a registered recipient.

As shown in FIG. 2, the operation starts by a user accessing the delivery service registration engine 160 and registering with the delivery service, which includes providing user inputs specifying data regarding the user and an initial set of entities with which the user is associated which serve as a basis for generating an initial entity-to-entity mesh (EEM) (step 202). The TEEM generation engine 110 operates to generate an initial EEM, such as initial EEM 155 in FIG. 1, by generating relationships between entities based on the registration data (step 204). Based on the entities specified in the initial EEM, data retrieval, mining, and feature extraction are performed for the specified entities, and other entities discovered through accessing social and professional network computing systems, electronic communication systems, and other information source computing systems, characteristics of entities and relationships between the user and the entities are identified from information gathered from these various information source computing systems (step 206).

The features extracted from the gathered information are input to one or more AI models, which process the initial EEM relationships, other potential relationships identified from the data gathering, mining, and feature extraction, as well as the other features extracted from data from the various information source computing systems, with regard to the user and other identified entities having potential relationships with the user, to generate an updated and expanded EEM referred to as the Trusted Entity-to-Entity Mesh (TEEM), such as TEEM 156 (step 208). Thereafter, one or more AI models operate on the features for the relationships specified in the TEEM to generate baseline surrogate recipient scores for each entity-relationship in the TEEM (step 210). The operation then terminates.

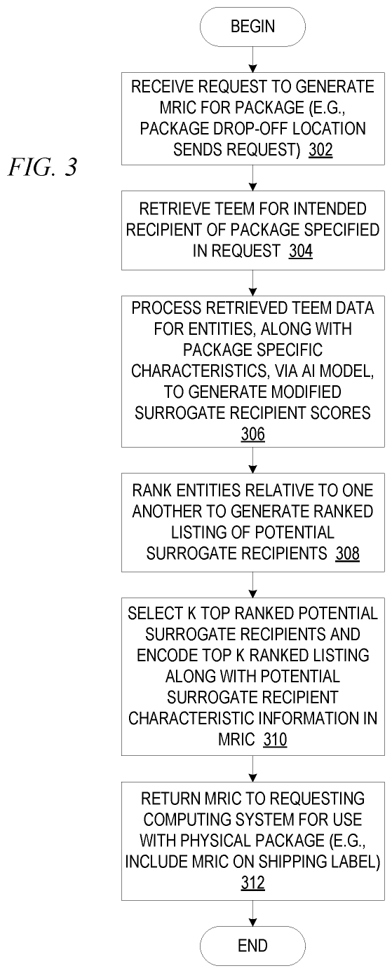

FIG. 3 is a flowchart outlining an example process of an improved computing tool with regard to the generation of an MRIC in accordance with one illustrative embodiment. The operation outlined in FIG. 3 may be performed for example, by the multi-recipient information code (MRIC) generation engine 120 in combination with the recipient database 150 of the AI based goods delivery logistics system 100 in FIG. 1, for example. Each of the operations set forth in FIG. 3 are performed by specifically configured computer logic implementing these elements of the AI based goods delivery logistics system 100, even though the operation may be performed in response to a request received from a package drop-off location computing system based on user input.

As shown in FIG. 3, the operation starts with the AI based goods delivery logistics system 100 receiving a request to generate a multi-recipient information code (MRIC) for a package, such as a package containing one or more items/goods that is dropped off for delivery at a package drop-off location 180 in FIG. 1, for example (step 302). Based on the identification of the intended recipient for the delivery of the package as specified in the MRIC request that is received in step 302, the TEEM data structure corresponding to the intended recipient of the package is retrieved from the recipient database 150 (step 304). The retrieved TEEM data structure is processed via one or more AI models to generate a modified surrogate recipient score, where the information processed includes information about the entities with which the intended recipient has determined relationships as specified in the TEEM, the baseline surrogate recipient scores specified in the TEEM for these other entities/relationships, and characteristics of the package and/or items/goods in the package (step 306).

Based on the modified surrogate recipient scores for the various entities, the entities are ranked relative to one another to generate a ranked listing of potential surrogate recipients (step 308). The top K ranked potential surrogate recipients are selected, where K may be any desired integer value, and the top K ranked listing is encoded, along with potential surrogate recipient characteristic information for the top K ranked potential surrogate recipients, in a MRIC (step 310). The generated MRIC is returned to the requesting computing system for use with the physical package, such as at the package drop-off location for generation of a shipping label that includes the MRIC to affix to the package (step 312). The operation then terminates.

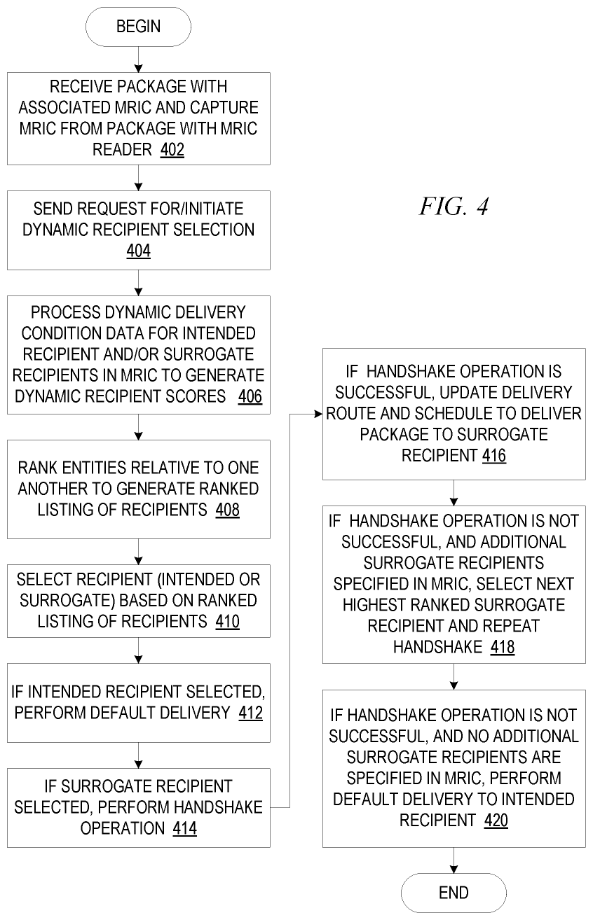

FIG. 4 is a flowchart outlining an example process of an improved computing tool with regard to the use of an MRIC by a delivery service for routing delivery of a package to a surrogate recipient in accordance with one illustrative embodiment. The operation outlined in FIG. 4 may be performed for example, by the AI based goods delivery logistics system 100 operating in conjunction with a local logistics computing system 144, or entirely within a local logistics computing system 144 operating based on a local dynamic surrogate recipient selection engine 130, depending on the desired implementation. Each of the operations set forth in FIG. 4 are performed by specifically configured computer logic implementing these elements of the AI based goods delivery logistics system 100 and/or local logistics computing system 144, even though the operation may be performed responsive to user input and/or may provide output to a human being for use in routing or otherwise directing delivery of a physical package to a recipient.

As shown in FIG. 4, the operation starts with the receipt of the package with associated MRIC at a location where the associated MRIC is read by an MRIC reader device (step 402). A request is sent to a remotely located AI based delivery logistics system, or an operation is initiated locally, to perform a dynamic recipient selection operation (step 404). Dynamic delivery condition data is retrieved and processed for the intended recipient and/or surrogate recipients specified in the MRIC, so as to generate dynamic recipient scores (step 406). The entities in the listing specified in the MRIC are ranked relative to each other based on the dynamic recipient scores (step 408). A recipient is selected from the listing, e.g., either the intended recipient or a surrogate recipient, based on the ranked listing of recipients (step 410).

If the intended recipient is the selected recipient, then a default, normal delivery operation to the intended recipient is follows (step 412). If a surrogate recipient is selected, a handshake operation is performed between the intended recipient and the surrogate recipient to make sure that all parties agree or consent to the delivery of the package to a surrogate recipient (step 414). If the handshake operation is successful, i.e., all parties agree, then the delivery route and schedule are updated to deliver the package to the surrogate recipient (step 416). If the handshake operation is not successful, and additional surrogate recipients are specified in the MRIC, a next highest ranked surrogate recipient is selected and the handshake operation is repeated (step 418). If the handshake operation is not successful, and no additional surrogate recipients are specified in the MRIC and which have not already had handshake attempts made, then a default delivery operation is performed to the intended recipient (step 420). The operation then terminates.

As can be seen from the above description with regard to FIGS. 1-4, the illustrative embodiments are specifically directed to an improved computing tool that improves the way in which package delivery logistics computing systems determine how to route packages to secure alternative recipients such that the intended recipient can be assured that their packages are not being left in unsecured locations, and such that sources of frustration or inconvenience on the intended recipient are reduced. Thus, it should be appreciated that the present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool.

In particular, the improved computing tool of the illustrative embodiments specifically provides an artificial intelligence based goods delivery logistics computing system, such as AI based goods delivery logistics system 100 in FIG. 1, for example, and/or the other specific computing tools at the drop-off location, delivery hub, and courier computing device which operate in conjunction with the AI based goods delivery logistics computing system, e.g., packaging/labeling computing system(s) 182, MRIC reader 142 and local logistics computing system 144, and applications executed on courier computing device 146 for interfacing with the delivery hub computing tools. The improved computing tool implements mechanism and functionality, such as the various mechanisms and functionality described previously with regard to various ones of the elements 100-192 in FIG. 1, which cannot be practically performed by human beings either outside of, or with the assistance of, a technical environment, such as a mental process or the like. The improved computing tool provides a practical application of the methodology at least in that the improved computing tool is able to select a surrogate recipient for delivery of physical packages containing items/goods specifically based on an artificial intelligence based evaluation of potential surrogate recipients that have artificial intelligence identified relationships with the intended recipient, the characteristics of these potential surrogate recipients and their relationships with the intended recipient, the characteristics of the package being delivered, and the current dynamic characteristics of the delivery conditions.

Moreover, unless otherwise specified herein, the functions of the illustrative embodiments are intended to be performed using automated processes without human intervention and thus, are not reciting any method of organizing human activity. To the contrary, while some of the mechanisms of the illustrative embodiments may interact with human beings through graphical user interfaces on various computing devices, such as sending notifications to human beings (e.g., the intended recipient and the selected surrogate recipient, as well as the human courier), the actual determinations of surrogate recipients and other artificial intelligence based functions described herein are performed by application specific computer logic, data structures, and functions of improved computing tools without human intervention. Furthermore, even though the present invention may provide an improved computing system that ultimately assists human beings in delivery of packages to recipients in a secure and more convenient manner, the illustrative embodiments of the present invention are not directed to this benefit, but rather to the specific operations performed by the specific improved computing tool of the present invention which facilitate the performance of a particular combination of computer specific operations by specific computer mechanisms that achieve this result in a specific manner that implements artificial intelligence technology. Thus, the illustrative embodiments are not organizing any human activity, but are in fact directed to the automated logic and functionality of an improved computing tool.

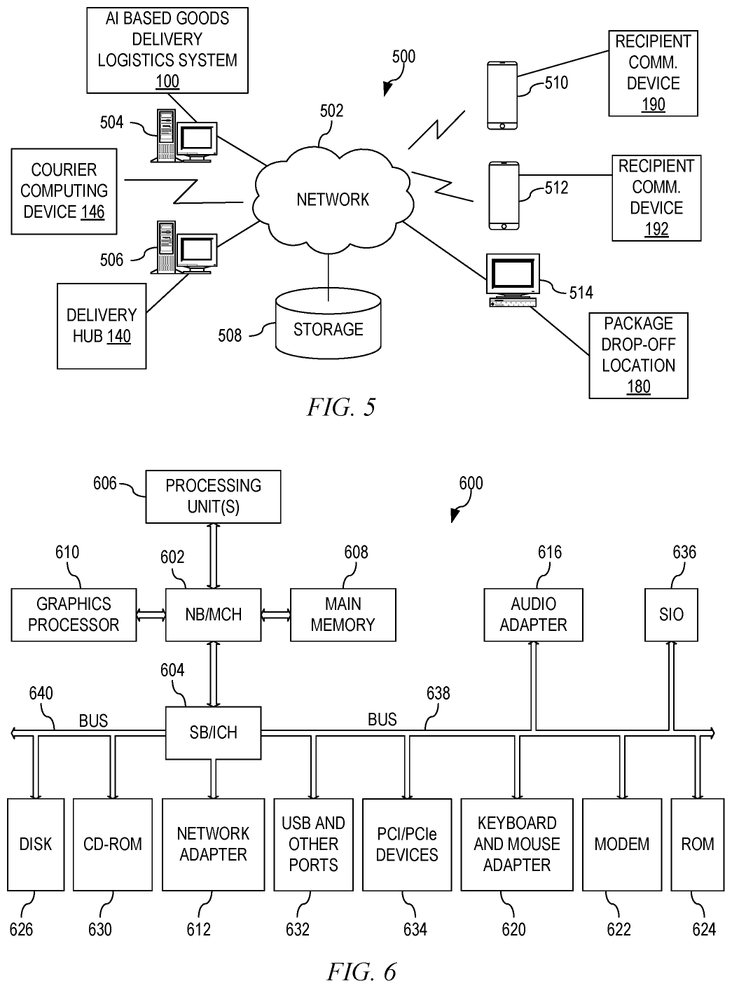

Thus, the illustrative embodiments may be utilized in many different types of data processing environments. In order to provide a context for the description of the specific elements and functionality of the illustrative embodiments, FIGS. 5 and 6 are provided hereafter as example environments in which aspects of the illustrative embodiments may be implemented. It should be appreciated that FIGS. 5 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 5 depicts a pictorial representation of an example distributed data processing system in which aspects of the illustrative embodiments may be implemented. Distributed data processing system 500 may include a network of computers in which aspects of the illustrative embodiments may be implemented. The distributed data processing system 500 contains at least one network 502, which is the medium used to provide communication links between various devices and computers connected together within distributed data processing system 500. The network 502 may include connections, such as wire, wireless communication links, or fiber optic cables.

In the depicted example, server 504 and server 506 are connected to network 502 along with storage unit 508. In addition, clients 510, 512, and 514 are also connected to network 502. These clients 510, 512, and 514 may be, for example, personal computers, network computers, or the like. In the depicted example, server 504 provides data, such as boot files, operating system images, and applications to the clients 510, 512, and 514. Clients 510, 512, and 514 are clients to server 504 in the depicted example. Distributed data processing system 500 may include additional servers, clients, and other devices not shown.

In the depicted example, distributed data processing system 500 is the Internet with network 502 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 500 may also be implemented to include a number of different types of networks, such as for example, an intranet, a local area network (LAN), a wide area network (WAN), or the like. As stated above, FIG. 5 is intended as an example, not as an architectural limitation for different embodiments of the present invention, and therefore, the particular elements shown in FIG. 5 should not be considered limiting with regard to the environments in which the illustrative embodiments of the present invention may be implemented.

As shown in FIG. 5, one or more of the computing devices, e.g., server 504, may be specifically configured to implement an AI based goods delivery logistics system 100. In addition, one or more computing devices may be configured to provide other elements of a distributed data processing system that work in conjunction with the AI based goods delivery logistics system 100 in a manner according to one or more illustrative embodiments described herein above. For example, the server 506 may implement one or more computing systems for a delivery hub 140, client computing device 514 may implement one or more computing systems associated with a package drop-off location 180, clients 510 and 512 may represent mobile computing devices or mobile communication devices with computing capability, e.g., smartphones or the like, which operate as recipient communication devices 190 and 192 for performing handshake operations or the like, and additional courier computing device(s) 146 may operate via network 502 to interact with the delivery hub 140. Some of these devices may communicate with the other devices via the network 502 using wireless data communications and/or wired data communications.

The configuring of the computing devices to implement various elements of illustrative embodiments of the present invention may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 504, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments. It should be appreciated that once the computing device is configured in one of these ways, the computing device becomes a specialized computing device specifically configured to implement the mechanisms of one or more elements of the illustrative embodiments and is not a general purpose computing device.

As noted above, the mechanisms of the illustrative embodiments utilize specifically configured computing devices, or data processing systems, to perform the operations for AI based goods delivery logistics which operate to select surrogate recipients, when appropriate, based on an AI based evaluation of relationships between the intended recipient and potential surrogate recipients, package characteristics, and dynamic delivery conditions. These computing devices, or data processing systems, may comprise various hardware elements which are specifically configured, either through hardware configuration, software configuration, or a combination of hardware and software configuration, to implement one or more of the systems/subsystems described herein. FIG. 6 is a block diagram of just one example data processing system in which aspects of the illustrative embodiments may be implemented. Data processing system 600 is an example of a computer, such as server 504 in FIG. 5, in which computer usable code or instructions implementing the processes and aspects of the illustrative embodiments of the present invention may be located and/or executed so as to achieve the operation, output, and external effects of the illustrative embodiments as described herein.

In the depicted example, data processing system 600 employs a hub architecture including north bridge and memory controller hub (NB/MCH) 602 and south bridge and input/output (I/O) controller hub (SB/ICH) 604. Processing unit 606, main memory 608, and graphics processor 610 are connected to NB/MCH 602. Graphics processor 610 may be connected to NB/MCH 602 through an accelerated graphics port (AGP).

In the depicted example, local area network (LAN) adapter 612 connects to SB/ICH 604. Audio adapter 616, keyboard and mouse adapter 620, modem 622, read only memory (ROM) 624, hard disk drive (HDD) 626, CD-ROM drive 630, universal serial bus (USB) ports and other communication ports 632, and PCI/PCIe devices 634 connect to SB/ICH 604 through bus 638 and bus 640. PCI/PCIe devices may include, for example, Ethernet adapters, add-in cards, and PC cards for notebook computers. PCI uses a card bus controller, while PCIe does not. ROM 624 may be, for example, a flash basic input/output system (BIOS).

HDD 626 and CD-ROM drive 630 connect to SB/ICH 604 through bus 640. HDD 626 and CD-ROM drive 630 may use, for example, an integrated drive electronics (IDE) or serial advanced technology attachment (SATA) interface. Super I/O (SIO) device 636 may be connected to SB/ICH 604.

An operating system runs on processing unit 606. The operating system coordinates and provides control of various components within the data processing system 600 in FIG. 6. As a client, the operating system may be a commercially available operating system such as Microsoft® Windows 10®. An object-oriented programming system, such as the Java™ programming system, may run in conjunction with the operating system and provides calls to the operating system from Java™ programs or applications executing on data processing system 600.

As a server, data processing system 600 may be, for example, an IBM eServer™ System p® computer system, Power™ processor based computer system, or the like, running the Advanced Interactive Executive (AIX®) operating system or the LINUX® operating system. Data processing system 600 may be a symmetric multiprocessor (SMP) system including a plurality of processors in processing unit 606. Alternatively, a single processor system may be employed.

Instructions for the operating system, the object-oriented programming system, and applications or programs are located on storage devices, such as HDD 626, and may be loaded into main memory 608 for execution by processing unit 606. The processes for illustrative embodiments of the present invention may be performed by processing unit 606 using computer usable program code, which may be located in a memory such as, for example, main memory 608, ROM 624, or in one or more peripheral devices 626 and 630, for example.

A bus system, such as bus 638 or bus 640 as shown in FIG. 6, may be comprised of one or more buses. Of course, the bus system may be implemented using any type of communication fabric or architecture that provides for a transfer of data between different components or devices attached to the fabric or architecture. A communication unit, such as modem 622 or network adapter 612 of FIG. 6, may include one or more devices used to transmit and receive data. A memory may be, for example, main memory 608, ROM 624, or a cache such as found in NB/MCH 602 in FIG. 6.

As mentioned above, in some illustrative embodiments the mechanisms of the illustrative embodiments may be implemented as application specific hardware, firmware, or the like, application software stored in a storage device, such as HDD 626 and loaded into memory, such as main memory 608, for executed by one or more hardware processors, such as processing unit 606, or the like. As such, the computing device shown in FIG. 6 becomes specifically configured to implement the mechanisms of the illustrative embodiments and specifically configured to perform the operations and generate the outputs described herein.

Those of ordinary skill in the art will appreciate that the hardware in FIGS. 5 and 6 may vary depending on the implementation. Other internal hardware or peripheral devices, such as flash memory, equivalent non-volatile memory, or optical disk drives and the like, may be used in addition to or in place of the hardware depicted in FIGS. 5 and 6. Also, the processes of the illustrative embodiments may be applied to a multiprocessor data processing system, other than the SMP system mentioned previously, without departing from the spirit and scope of the present invention.

Moreover, the data processing system 600 may take the form of any of a number of different data processing systems including client computing devices, server computing devices, a tablet computer, laptop computer, telephone or other communication device, a personal digital assistant (PDA), or the like. In some illustrative examples, data processing system 600 may be a portable computing device that is configured with flash memory to provide non-volatile memory for storing operating system files and/or user-generated data, for example. Essentially, data processing system 600 may be any known or later developed data processing system without architectural limitation.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, performed by an artificial intelligence (AI) based delivery service logistics computing system, comprising:
generating a trusted entity-to-entity mesh (TEEM) data structure for a user, the TEEM data structure comprising relationships between the user and one or more other entities that are potential surrogate recipients of physical packages by a delivery service;
performing, by one or more artificial intelligence (AI) computer models of the AI based delivery service logistics computing system, AI analysis of characteristics of the relationships between the user and the one or more other entities resulting in surrogate recipient scores for each of the one or more other entities;
ranking the one or more other entities relative to one another according to their surrogate recipient scores;
selecting a set of one or more selected entities, from the one or more entities as potential surrogate recipients of a physical package whose intended recipient is the user;
generating an encoded multi-recipient information code (MRIC) for the physical package specifying characteristics of each of the one or more selected entities in the set of one or more selected entities, in an encoded format; and
controlling delivery of the package to a recipient based on the MRIC and dynamic delivery conditions, wherein the recipient is one of the user or a surrogate recipient that is a selected entity in the set of one or more selected entities.

2. The method of claim 1, wherein the encoded MRIC is encoded on a physical attachment affixed to the physical package.

3. The method of claim 2, wherein controlling delivery of the package to a recipient based on the MRIC and dynamic delivery conditions comprises:
reading the encoded MRIC from the physical attachment using a MRIC reader device;
decoding the MRIC read from the physical attachment; and
selecting a surrogate recipient from the set of one or more selected entities encoded in the MRIC based on characteristics of the one or more selected entities and current delivery conditions at approximately a time of reading the encoded MRIC from the physical attachment.

4. The method of claim 3, wherein the dynamic delivery conditions comprise fragility of the package, confidentiality of the package, size of the package, weather conditions, time of day, day of week, and traffic conditions for a geographical area corresponding to the user.

5. The method of claim 1, wherein performing the AI analysis of characteristics of the relationships between the user and the one or more other entities comprises, for each of the one or more other entities, scoring a type of relationship determined to exist between the user and the other entity, scoring an amount of co-location or intersection of location between the user and the other entity, scoring of a familiarity of natural language content in communications between the user and the other entity, scoring a degree of communication between the user and the other entity, scoring a type of communication engaged in between the user and the other entity, and scoring personality insight evaluations for the user and the other entity.

6. The method of claim 1, wherein generating the TEEM data structure comprises:
processing data, corresponding to the user, from data collected from one or more of social networking websites, professional networking websites, electronic communication services, location determination services, or mapping services, to generate a listing of potentially related recipient entities; and
processing feature data, extracted from the data corresponding to the potentially related recipient entities, via one or more machine learning trained AI computer models, to classify relationships between the potentially related recipient entities and the user with regard to a predetermined set of relationship types.

7. The method of claim 6, wherein the feature data comprises one or more of logged engagement data for social network feeds, public/workplace collaboration computing system stacks, logs or historical data regarding location of the user and entities, electronic communication logs, and wherein processing the feature data comprises identifying correlations in patterns of characteristics of the entities to determine a level of trust and a level of engagement of the user with each of the one or more other entities.

8. The method of claim 1, wherein controlling delivery of the package to a recipient comprises:
processing the MRIC and dynamic delivery conditions via one or more machine learning trained AI computer models to predict, for a first selected entity of the one or more selected entities specified in the MRIC, whether or not a location of the first selected entity will intersect with a delivery time and location of the package;
selecting the first selected entity to be a surrogate recipient for the package in response to a prediction that the location of the first selected entity will intersect with the delivery time and location of the package; and
selecting a second selected entity of the one or more selected entities specified in the MRIC in response to the location of the first selected entity not being predicted as intersecting with the delivery time and location of the package.

9. The method of claim 1, wherein generating the TEEM data structure comprises:
generating a recipient entry data structure in a recipient database, wherein the registered user entry data structure comprises an initial set of entities and relationships between the user and the entities in the initial set of entities;
generating an initial entity-to-entity mesh (EEM) based on the initial set of entities and the relationships between the user and the entities in the initial set of entities, wherein entities are represented as nodes in the EEM and relationships are represented as edges between nodes in the EEM; and
expanding the EEM with one or more additional nodes and relationships corresponding to one or more additional entities that are potential surrogate recipients of physical packages by the delivery service, at least by analyzing data gathered from one or more other information source computing systems to identify the one or more additional entities with which the user has a relationship and adding nodes and edges to the EEM for the one or more additional entities, wherein the TEEM is an ontology data structure that comprises nodes and edges corresponding to the initial set of entities and nodes and edges corresponding to the one or more additional entities.

10. The method of claim 9, wherein generating the recipient entry data structure further comprises receiving user input specifying account details for the user for at least one of a social networking or professional networking website, and one or more electronic communication services, and wherein generating the TEEM comprises processing interactions by the user with one or more other entities via at least one of the social networking or professional networking website and the one or more electronic communication services, to identify relationships with the one or more other entities and characteristics of the relationships with the one or more other entities.

11. A computer program product comprising a computer readable storage medium having a computer readable program stored therein, wherein the computer readable program, when executed on a data processing system, causes the data processing system to:
generate a trusted entity-to-entity mesh (TEEM) data structure for a user, the TEEM data structure comprising relationships between the user and one or more other entities that are potential surrogate recipients of physical packages by a delivery service;
perform, by one or more artificial intelligence (AI) computer models executing on the data processing system, AI analysis of characteristics of the relationships between the user and the one or more other entities resulting in surrogate recipient scores for each of the one or more other entities;
rank the one or more other entities relative to one another according to their surrogate recipient scores;
select a set of one or more selected entities, from the one or more entities as potential surrogate recipients of a physical package whose intended recipient is the user;
generate an encoded multi-recipient information code (MRIC) for the physical package specifying characteristics of each of the one or more selected entities in the set of one or more selected entities, in an encoded format; and
control delivery of the package to a recipient based on the MRIC and dynamic delivery conditions, wherein the recipient is one of the user or a surrogate recipient that is a selected entity in the set of one or more selected entities.

12. The computer program product of claim 11, wherein the encoded MRIC is encoded on a physical attachment affixed to the physical package.

13. The computer program product of claim 12, wherein the computer readable program further causes the data processing system to control delivery of the package to a recipient based on the MRIC and dynamic delivery conditions at least by:
reading the encoded MRIC from the physical attachment using a MRIC reader device;
decoding the MRIC read from the physical attachment; and
selecting a surrogate recipient from the set of one or more selected entities encoded in the MRIC based on characteristics of the one or more selected entities and current delivery conditions at approximately a time of reading the encoded MRIC from the physical attachment.

14. The computer program product of claim 13, wherein the dynamic delivery conditions comprise fragility of the package, confidentiality of the package, size of the package, weather conditions, time of day, day of week, and traffic conditions for a geographical area corresponding to the user.

15. The computer program product of claim 11, wherein the computer readable program further causes the data processing system to perform the AI analysis of characteristics of the relationships between the user and the one or more other entities at least by, for each of the one or more other entities, scoring a type of relationship determined to exist between the user and the other entity, scoring an amount of co-location or intersection of location between the user and the other entity, scoring of a familiarity of natural language content in communications between the user and the other entity, scoring a degree of communication between the user and the other entity, scoring a type of communication engaged in between the user and the other entity, and scoring personality insight evaluations for the user and the other entity.

16. The computer program product of claim 11, wherein the computer readable program further causes the data processing system to generate the TEEM data structure at least by:
processing data, corresponding to the user, from data collected from one or more of social networking websites, professional networking websites, electronic communication services, location determination services, or mapping services, to generate a listing of potentially related recipient entities; and
processing feature data, extracted from the data corresponding to the potentially related recipient entities, via one or more machine learning trained AI computer models, to classify relationships between the potentially related recipient entities and the user with regard to a predetermined set of relationship types.

17. The computer program product of claim 16, wherein the feature data comprises one or more of logged engagement data for social network feeds, public/workplace collaboration computing system stacks, logs or historical data regarding location of the user and entities, electronic communication logs, and wherein processing the feature data comprises identifying correlations in patterns of characteristics of the entities to determine a level of trust and a level of engagement of the user with each of the one or more other entities.

18. The computer program product of claim 11, wherein the computer readable program further causes the data processing system to control delivery of the package to a recipient at least by:
processing the MRIC and dynamic delivery conditions via one or more machine learning trained AI computer models to predict, for a first selected entity of the one or more selected entities specified in the MRIC, whether or not a location of the first selected entity will intersect with a delivery time and location of the package;
selecting the first selected entity to be a surrogate recipient for the package in response to a prediction that the location of the first selected entity will intersect with the delivery time and location of the package; and
selecting a second selected entity of the one or more selected entities specified in the MRIC in response to the location of the first selected entity not being predicted as intersecting with the delivery time and location of the package.

19. The computer program product of claim 11, wherein the computer readable program further causes the data processing system to generate the TEEM data structure at least by:
generating a recipient entry data structure in a recipient database, wherein the registered use entry data structure comprises an initial set of entities and relationships between the user and the entities in the initial set of entities;
generating an initial entity-to-entity mesh (EEM) based on the initial set of entities and the relationships between the user and the entities in the initial set of entities, wherein entities are represented as nodes in the EEM and relationships are represented as edges between nodes in the EEM; and
expanding the EEM with one or more additional nodes and relationships corresponding to one or more additional entities that are potential surrogate recipients of physical packages by the delivery service, at least by analyzing data gathered from one or more other information source computing systems to identify the one or more additional entities with which the user has a relationship and adding nodes and edges to the EEM for the one or more additional entities, wherein the TEEM is an ontology data structure that comprises nodes and edges corresponding to the initial set of entities and nodes and edges corresponding to the one or more additional entities.

20. An apparatus comprising:
a processor; and
a memory coupled to the processor, wherein the memory comprises instructions which, when executed by the processor, cause the processor to:
generate a trusted entity-to-entity mesh (TEEM) data structure for a user, the TEEM data structure comprising relationships between the user and one or more other entities that are potential surrogate recipients of physical packages by a delivery service;
perform, by one or more artificial intelligence (AI) computer models executing on the data processing system, AI analysis of characteristics of the relationships between the user and the one or more other entities resulting in surrogate recipient scores for each of the one or more other entities;
rank the one or more other entities relative to one another according to their surrogate recipient scores;
select a set of one or more selected entities, from the one or more entities as potential surrogate recipients of a physical package whose intended recipient is the user;
generate an encoded multi-recipient information code (MRIC) for the physical package specifying characteristics of each of the one or more selected entities in the set of one or more selected entities, in an encoded format; and
control delivery of the package to a recipient based on the MRIC and dynamic delivery conditions, wherein the recipient is one of the user or a surrogate recipient that is a selected entity in the set of one or more selected entities.
